(19) United States
(12) Patent Application Publication
(10) Pub. No.: US 2017/0063883 A1
(43) Pub. Date: Mar. 2, 2017

(54) METADATA INFORMATION BASED FILE PROCESSING

(71) Applicant: Fortinet, Inc., Sunnyvale, CA (US)

(72) Inventor: Ignacio Franzoni Martinez, Barcelona (ES)

(73) Assignee: FORTINET, INC., Sunnyvale, CA (US)

(21) Appl. No.: 14/836,685

(22) Filed: Aug. 26, 2015

(51) Int. Cl. H04L 29/06

(52) U.S. Cl. CPC H04L 63/1416; H04L 63/102; H04L 63/107

(57) ABSTRACT

Methods and systems for network level file processing based on metadata information retrieved from a file are provided. According to one embodiment, a file is received by a network security appliance. Metadata information is extracted from the file. The extracted metadata information is processed based on one or more defined rules. An action is taken on one or more of the file or a sender of the file based on an outcome of the processing.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2015, Fortinet, Inc.

### BACKGROUND

Field

Embodiments of the present invention generally relate to data loss prevention and protection. More particularly, embodiments of the present invention relate to data loss prevention (DLP) implemented at a network security device and/or at a user device to prevent transfer of sensitive data/files from a secure device/network to an unauthorized person or an outside network.

Description of the Related Art

Information/data within an organization is generally categorized as classified/sensitive data and non-classified data due to several reasons such as business reasons and legal reasons. Classified/sensitive information/data may include data on customers (or patients), contracts, deliveries, supplies, employees, manufacturing, or the like. In addition, sensitive information may include Intellectual Property (IP) of an organization such as software code developed by employees of the organization, documents describing inventions conceived by employees of the organization, etc. With respect to software companies, for example, a trade secret algorithm, or system architecture and encryption keys etc. may be categorized as classified/sensitive data. Similarly, with respect to a government/military agency or a defense contractor, for example, war plans, HR information, secret project details, policy decisions, reports on arms and ammunition and the like may be categorized as classified/sensitive data.

Such classified/sensitive data can be sent/transferred by a mischievous user or an unethical employee to an unauthorized user within or outside the secure network. For instance, an employee can transfer a classified file to his personal email account or to an outside file storage server from his authorized office email address or from his authorized computing device, or the employee can take picture of a classified data from his mobile phone and forward it to an unauthorized person. Such transfer of sensitive information/data may not be in the interest of the organization, and therefore the problem of data loss prevention has compounded with free use of multimedia devices having image capturing capabilities and leakage/authorized transfer of information needs to be, as a result, prevented in the interest of the organization.

Data privacy and data loss prevention (DLP) are critical for any organization in today's electronic information technology age as existing computing devices within a network may contain/store significant sensitive data/information that can be transferred in unlimited volume in very less time. For organizations such as corporate establishments, hospitals, financial institution, R&D centers, government institutions, defense establishments etc, data leakage has therefore become one of the major challenges.

In addition to an organization's own interest in preventing/protecting data loss/theft, there may be regulatory obligations on the organizations to prevent such data loss/leakage. For instance, financial institutions may have an obligation to prevent leakage of information about their customers, and hospitals may have an obligation to protect health care information.

There are several existing systems and methods known for data loss prevention. However, most of the existing systems and methods are based on analysis of the actual content being transferred where such analysis of actual content may be time consuming, may not even be accurate/reliable at all times. Such existing methods and systems may also unnecessary delay an authorized transaction as a network device may take a long time to analyze the actual contents and apply one or more policies/rules to decide whether to allow a particular transaction/transfer or not. Existing systems and methods are typically hardware/software oriented platforms that monitor and prevent sensitive information from being leaked to outside organizations/entities/unsecured networks. Such DLP systems are also known as data leak prevention systems or information leak prevention systems. Data Loss Prevention (DLP) systems apply configurable DLP policy rules to identify files that contain sensitive data and therefore should not be forwarded outside of a particular enterprise network or specific set of host computers or storage devices.

Some of the existing DLP systems are implemented at network gateway/security devices that analyze all outgoing network traffic for unauthorized transmission of sensitive information/data. A typical DLP system may include a content extractor, a content-matching engine, and a rules-enforcement engine. Data analyzed by a DLP system may be processed by these engines to determine whether an enforcement action such as blocking transmission of a file, quarantining a file, or creating a security violation should be performed. The two most computationally expensive stages in DLP include content extraction and content matching, which consume a lot of resources, causing application timeouts, higher load on network processors, and delay in the traffic. Because of the cost of content extraction and matching, efficient and thorough DLP may not be possible using traditional DLP systems.

Apart from being computationally expensive, existing DLP systems cannot even scan encrypted/password protected files, and in such cases users can send sensitive data outside their computing system/protected network using encrypted or password-protected files. Furthermore, existing file scanning systems rely on file content based scanning and hence are not transparent.

There is, therefore, a need for methods and systems that provide faster analysis of files being transferred, and that allow an efficient DLP implementation that can take appropriate decisions without consuming expensive resources and delaying the transfer.

### SUMMARY

Methods and systems are described for network level file processing based on metadata information retrieved from a file. According to one embodiment, a file is received by a network security appliance. Metadata information is extracted from the file. The extracted metadata information is processed based on one or more defined rules. An action is taken on one or more of the file or a sender of the file based on an outcome of the processing.

Other features of embodiments of the present invention will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary network architecture in which embodiments of the present invention can be implemented.

FIG. 2. illustrates an exemplary network architecture having a DLP system implemented within a network device in accordance with an embodiment of the present disclosure.

FIG. 3 illustrates exemplary functional modules of a DLP system that is configured to perform metadata information based file processing in accordance with an embodiment of the present invention.

FIG. 4 illustrates an exemplary representation of metadata information based file processing in accordance with an embodiment of the present disclosure.

FIG. 5 illustrates an exemplary flow diagram showing metadata information based file processing in accordance with an embodiment of the present invention.

FIG. 6 illustrates another exemplary flow diagram showing metadata information based file processing in accordance with an embodiment of the present invention.

FIG. 7 illustrates yet another exemplary flow diagram showing metadata information based image file processing in accordance with an embodiment of the present invention.

FIG. 8 is an exemplary computer system with which embodiments of the present invention may be utilized.

### DETAILED DESCRIPTION

Methods and systems are described for network level file processing based on metadata information retrieved from a file. In the following description, numerous specific details are set forth in order to provide a thorough understanding of embodiments of the present disclosure. It will be apparent to one skilled in the art that embodiments of the present disclosure may be practiced without some of these specific details.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of conducting network auditing, it should be appreciated that the same has been done merely to illustrate the disclosure in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named

Methods and systems are described for network level file processing based on metadata information retrieved from a file. Aspects of the present disclosure relate to receiving a file, and extracting metadata information relating to the file to process the extracted metadata information with one or more defined rules, based on which an action (such as allow or deny or block) can be taken on the file or the sender thereof.

Aspects of the present disclosure further relate to a system having a file receive module that is configured to receive a file, and a metadata extraction module that is configured to extract metadata information relating to the file. The system can further include a metadata based policy implementation module that is configured to process the extracted metadata information based on one or more defined rules, and a metadata comparison based action module that is configured to take an action on the file and/or sender of the file based on outcome of the processing of the extracted metadata information.

In an aspect, metadata information of a file can include one or a combination of descriptive attributes of the file, structural attributes of the file, administrative attributes of the file, title, creation details, modification details, type of file, format details, identifier details, language details, location details, actions taken on the file, purpose of the file, rights relating to the file, platform of the file, company to which the file belongs, and security parameters of the file.

In another aspect, action that can be taken on the file can include one or a combination of blocking the file, allowing the file, blocking the sender of the file, erasing metadata of the file, modifying metadata of the file, logging the file, classifying the file in a category, classifying the sender of the file in a class, generating a security alert, changing attributes of the file, and quarantining the file.

In an exemplary embodiment, when the file at issue is an image file and includes Exchangeable Image File Format (EXIF) information, at least one rule of the one or more defined rules can be configured to process the EXIF information in order to determine if the EXIF information indicates malicious data.

In yet another aspect, GPS coordinates of the file can be determined and processed with at least rule of the one or more defined rules, wherein an action can be taken on the file based on outcome of the processing. In yet another aspect, the metadata information to be extracted can be configurable and changed based on, for instance, the file type/extension/size/purpose/content/timestamp/file attributes, sender/receiver details, among other parameters. In another aspect, the metadata information can be extracted based on any or a combination of type of the file, creator of the file, data stored in the file, format of the file, data of creation of the file, date of modification of the file, sender of the file, desired purpose of processing the file, configured security policies, and configured information attributes, among other like attributes.

In yet another aspect, the one or more defined rules can be configurable and selectable based on for instance, the user/sender/receiver in context, file parameters/attributes, timestamp of evaluation, purpose of evaluation, purpose of the file, network path that the file has transmitted through, administrator rights, among other like factors. In an aspect, content stored in the file can be processed along with the extracted metadata information to determine the action, wherein, for instance, if the file is determined to be unsafe based on the metadata information, a defined part of the file, say the header or the data block can be removed/modified/hidden. Any other action can also be configured/defined and/or implemented on the file and/or the sender thereof, based on the file metadata information and processing of the information with respect one or more configured rules. In yet another embodiment, metadata information of a file can also be updated by the DLP system in real-time.

In another aspect, the present disclosure further relates to a method that includes the steps of receiving a file, extracting metadata information from the file, processing the extracted metadata information based on one or more defined rules, and taking an action on one or more of the file or a sender of the file based on an outcome of the processing.

### TERMINOLOGY

Brief definitions of terms used throughout this application are given below.

The phrase “network appliance” generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, Layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

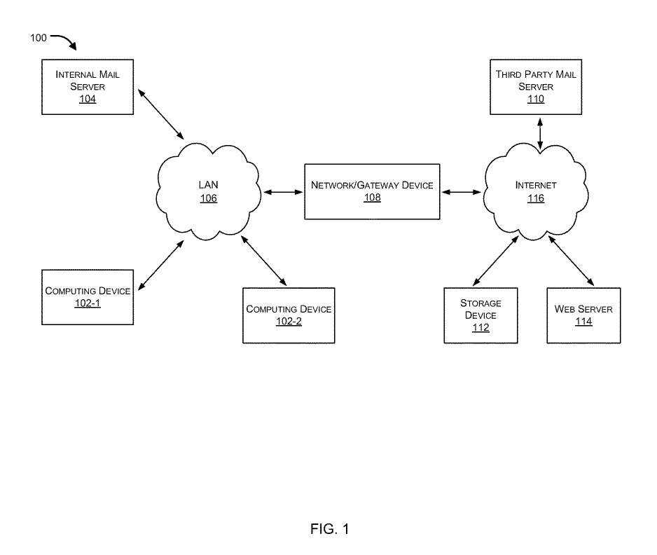

FIG. 1 illustrates an exemplary network architecture 100 in which embodiments of the present disclosure can be implemented. The network architecture, as shown in FIG. 1, is a mere representation of different computing devices that are operatively coupled with each other through a local area network (LAN) or to an external network through the Internet 116. An organization may have a LAN 106 to enable communication within the organization between different computing devices such as computing device 102-1 and computer device 102-2, which may be collectively and interchangeably referred to as computing devices 102 hereinafter, and one or more web services such as internal mail server 104, storage server (not shown), printer, and other network resources within the organization.

As these devices are connected, a user inside LAN 106 may have access to a lot of information, which should only be used by the user for official purposes and should not be disclosed outside the organization. The risk of data loss/leak is increased when the user inside LAN 106 has access to Internet 116, using which the inside user may purposefully or mistakenly send confidential data to a third party mail server 110, or may store the data to an outside storage device 112 or may leak the data to a web server 114.

As shown in FIG. 1, a network/gateway device 108 can be logically interposed between LAN 106 and the Internet 116 for monitoring data traffic that passes through/from the LAN 106 to an external user/device. In different implementations, it is possible to place a network/gateway device 108 anywhere within the LAN 106 or the Internet 116 or between any two computing devices such as computing device 102-1 and 102-2. In different implementations, multiple of such network/gateway devices such as network/gateway device 108 can be configured to provide network routing between different computing devices.

In an aspect, network/gateway device 108 can include, but is not limited to, a router, a switch, a gateway, a hub, a firewall, an Intrusion Prevention System (IPS), an Intrusion Detection System (IDS), or a combination thereof. Such a network device 108 is generally implemented as a layer-2 or layer-3 (of the OSI reference model) network device, and can be configured to extract header details of communications/packets/files/data segments in order to determine basic information required for routing the respective packets/files and/or to understand different properties of the associated communications. Layer-2 and layer-3 devices are designed to extract basic packet information such as source address, destination address, content type, content format, and network protocol used by a network, without impacting the integrity of the communication and/or of the data packets/files. Such basic information can be analyzed to understand the type of content being transmitted, and also to protect the host and destination devices from any malicious content and/or network attacks.

In an exemplary implementation, confidential information of an organization that passes through LAN 106 to an outside user and/or a device can be detected and prevented by a network/gateway device 108. In another exemplary implementation, network/gateway device 108 can be configured to detect any data loss/leak by monitoring the data that passes through it and taking action on the data whenever required. In yet another exemplary implementation, data leak prevention (DLP) systems of the present disclosure can be implemented at network gateway/security devices such as 108 that can analyze outgoing network traffic for unauthorized transmission of sensitive information/data.

In an aspect of the present disclosure, network/gateway device 108 can be configured to receive a file that is intended to be transferred by a sender to a receiver, wherein the sender/receiver can be part of the LAN or part of the Internet or a combination thereof. For instance, a user of computing device 102-1 may wish to send a file to storage device 112, which can be, during transmission, received by network device 108, for instance. Those skilled in the art will appreciate that the illustrated network architecture having LAN 106, Internet 116, among other computing devices is completely exemplary and merely for illustration purposes, and any other network architecture can be configured (such as network device forming part of the LAN or network device being a network security device, among other like architectures), and would be completely within the scope of the present invention.

In an aspect of the present invention, once network device 108 receives a file transmitted within the payloads of a packet stream, the device 108 can be configured to extract metadata information that is associated with the file, and use one or more pre-defined/configured policy rules to process the extracted metadata information to determine if any action is to be taken on the file or a part thereof. In an aspect of the present disclosure, metadata information of a file can include one or a combination of descriptive attributes of the file, structural attributes of the file, administrative attributes of the file, title, creation details, modification details, type of file, format details, identifier details, language details, location details, actions taken on the file, purpose of the file, rights relating to the file, platform of the file, company to which the file belongs, and security parameters of the file.

Such metadata information can therefore be extracted, say in real-time by a network device 108 such as by a firewall or by an IPS/IDS in order to evaluate one or more attributes of the extracted metadata information based on a defined set of policy rules to determine an action that is to be taken on the file or the sender thereof. Such action can simply include blocking the file/user or allowing the file or taking company level action on the user or changing/hiding/encrypting the metadata information of the file. In another aspect, the action can also include one or a combination of erasing metadata of the file, modifying metadata of the file, logging the file, classifying the file in a category, classifying the sender of the file in a class, generating a security alert, changing attributes of the file, and quarantining the file, or any other action that is defined or decided to be taken, say by the administrator or the organization/network.

In yet another aspect, GPS coordinates contained within the metadata information of the received file can also be determined by the network device 108, and then processed with at least one rule of the one or more defined rules that pertain to location coordinate based analysis, wherein an action can be taken on the file based on outcome of the processing. In yet another aspect, the metadata information to be extracted can be configurable and changed based on, for instance, the file type/extension/size/purpose/content/timestamp/file attributes, sender/receiver details, among other parameters. In another aspect, the metadata information can be extracted based on any or a combination of type of the file, creator of the file, data stored in the file, format of the file, data of creation of the file, date of modification of the file, sender of the file, desired purpose of processing the file, configured security policies, and configured information attributes, among other like attributes. For instance, they type of metadata information that is extracted for a .exe file may be different that that extracted from a .pdf file due to the nature of malicious content that .exe files typically carry and the location in which such malicious content is carried. Similarly, the complexity/comprehensiveness of rules based on which the extracted metadata information is processed may be higher or stronger during analysis of a .jpg file when compared with a .txt file, for instance. Therefore, those skilled in the art will appreciate that metadata information to be extracted and rules to be applied on the extracted metadata information can be configured/defined or can be kept consistent depending on the implementation of the system. For instance, metadata information to be extracted from a file can change based on the sender or the receiver of the file, or the network from which it is sent, or the time of sending, or any other parameter. Similarly, even the policy rules that are to be applied on extracted metadata information can be configured based on the sender or the receiver of the file, or the network from which it is sent, or the time of transmission, or the network device in context, or any other configurable parameter/factor/attribute, all of which are completely within the scope of the present disclosure.

In yet another aspect, the one or more defined rules can be configurable and selectable based on for instance, the user/sender/receiver in context, file parameters/attributes, timestamp of evaluation, purpose of evaluation, purpose of the file, network path that the file has transmitted through, administrator rights, among other like factors. In an aspect, content stored in the file can be processed along with the extracted metadata information to determine the action, wherein, for instance, if the file is determined to be unsafe based on the metadata information, a defined part of the file, say the metadata information, header information or the file content can be removed/modified/hidden. Any other action can also be configured/defined and/or implemented on the file and/or the sender thereof, based on the file metadata information and processing of the information with respect one or more configured rules. In yet another embodiment, metadata information of a file can also be updated by the DLP system in real-time.

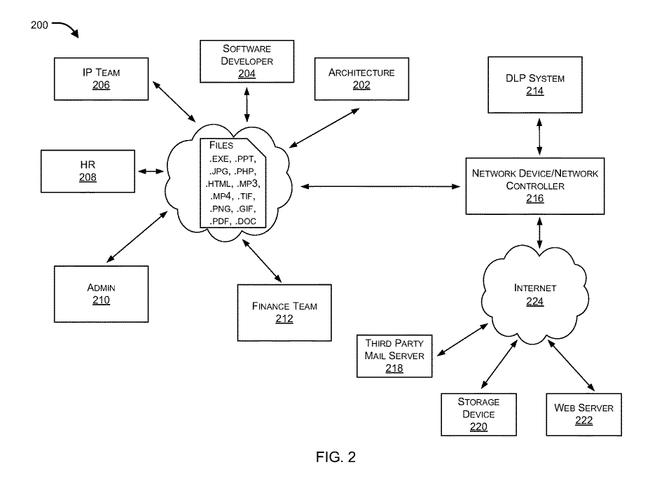

FIG. 2 illustrates an exemplary network architecture 200 having a Data Loss Prevention (DLP) system implemented within a network device 216 in accordance with an embodiment of the present disclosure. As shown in FIG. 2, a DLP system 214 can be integrated with network device/network controller 216, wherein controller 216 can pass basic packet information extracted from a data packet/file to DLP system 214 in order to detect any data loss/leakage. In an exemplary implementation, DLP system 214 can be integrated with network device/network controller 216 in order to avoid additional network latency/delay, wherein integration of DLP system 214 with network device/network controller 216 can have a benefit as the addition of the DLP system 214 does not add any extra network delay caused due to packet capture and analysis. DLP system 214 can be configured to receive all basic information related to a packet/file from network device/network controller 216, which any way would have captured the packet and would have extracted the basic information that may include information relating to protocol of communication, host address, destination address, type of file, and indication about the content of file etc.

In an exemplary implementation, DLP system 214 can monitor/control transfer any data file and/or executable such as .exe, .ppt, jpg, .php, .html, .mp3, .mp4, .tif, .png, .gif, .pdf, .doc or any other file types, originating from protected computing devices belonging to different departments or types of user groups (such as architecture group 202, software group 204, IP team 206, HR group 208, Admin department 210, finance team 212, among other like stakeholders). In an exemplary implementation, DLP system 214 can be configured to monitor files being sent from a computing device that is associated with a selected department or selected set of users. For instance, DLP system 214 can be configured to monitor data/files being transferred from IP team 206 and finance team 212 to outside users or organizations. In another exemplary implementation, DLP system 214 can be configured to monitor outgoing traffic originating from an organization and through Internet 224 in order to detect and prevent data loss/leak. In another instance, DLP system 214 can be configured to monitor data/file transfer that is targeted to an outside user or device such as to a third partly mail server 218, a storage device 220, or a web server 222. In an alternative embodiment, apart from receiving files/packets through controller 216, DLP system 214 can also be configured to intercept files/data packets being sent from, say a LAN of an organization, to the Internet 224 directly from the real-time traffic.

In an exemplary implementation, DLP system 214 can be configured to monitor transfer of only classified documents, wherein such documents can have an electronic marker that is indicative of them being classified. In another exemplary implementation, DLP system 214 can also be configured to monitor documents of a particular file type, or to monitor files belonging to a particular department/user, and therefore any such configuration of the DLP system 214 is completely within the scope of the present disclosure.

In an aspect, DLP system 214 can include a file metadata extractor that can be configured to extract metadata information associated with a received/given file that is, for instance, being transferred to entity that is outside the organization or to another department/user within the organization. In an aspect, DLP system 214 can further include a metadata matching engine that can be configured to match/process the extracted metadata information with a policy database, wherein the policy database can be represented as a set of configurable policy rules, and wherein the policy database can store such policy rules that can be modified/amended/added/deleted by an administrator of the system. Matching/processing the extracted metadata with the set of policy rules can enable identification of whether the metadata information is indicative of a security threat or whether the file can be allowed to pass through.

In an instance, one policy rule can be configured to determine if the creator of the file is from a defined list of users that are stored in the policy database (or in any other repository), based on which a decision on the transmission of the file can be taken. In another instance, another policy rule can be configured to determine the number of times the file has been forwarded/replied to, and if the number is greater than a defined threshold, an action can be taken on the file. Yet another policy rule can be configured to determine the department that the file belongs to, or when the file was created, or the number of times the file has undergone modifications, or the actions that have been taken on the file by other users that the file has been passed to, or any other information that can be retrieved as part of the metadata information from the file, based on which DLP system 214, independently or along with network device 216, can taken an action on the file, such as blocking the file, or enabling transmission of the file, or blocking the sender, or taking a legal/administrative action on sender/receiver, or deleting/modifying a portion of the file, or any other configurable action.

In an exemplary implementation, DLP system 214 can include a rule-enforcement engine that can be configured to take an action on the file depending on the outcome of the processing that is performed, with respect to one or policy rules, on the extracted metadata information. The outcome of such processing can be compared with one or more defined thresholds to determine what action is to be taken on the file, or a part thereof, or on the sender/receiver of the file. In an exemplary implementation, based on metadata matching, a rule-enforcement engine (not shown) can be configured to take appropriate enforcement actions such as blocking transmission of the file, quarantining the file, or sending alerts to appropriate people/stakeholders. As illustrated above, DLP system 214 can be integrated with network device/network controller 216 to avoid the packet capturing activity, wherein the packets can be captured by network device/network control 216 and can be shared with DLP system 214 for further analysis. As, in one embodiment, DLP system 214 is configured to extract only metadata information associated with a received file and not the content of the file, network delay may substantially be reduced when compared with the network delay that is otherwise caused by traditional DLP systems.

In an exemplary implementation, regular expressions and/or string based matching can be implemented while processing the extracted metadata information with one or more policy rules to enable, for instance, a multi-agent technique for faster metadata matching. In another exemplary implementation, one or more predefined policy rules, which may predominantly be metadata based policy rules, can be used by the metadata matching engine to detect any match of extracted metadata with classified/categorized metadata, wherein such classification/categorization of stored metadata can be done beforehand by the policy rules in a manner that values of one or more metadata fields of the received file can be compared with the stored values in order to determine various attributes of the file, based on which an action can be taken on the file. In an exemplary implementation, the rule-enforcement engine can be configured to take one or more pre-defined or “real-time defined” actions based on outcome of the matching. Pre-defined actions can include but are not limited to blocking the file/communication, logging the file/communication, allowing the file/communication, blocking the sender of the file, blacklisting/blocking the computing device that has initiated the transaction, erasing metadata information of the file before transmission, and among any other defined action. In an implementation, one or more pre-defined actions can be taken simultaneously depending on the level of confidentiality associated with the file/communication.

In an aspect, DLP system 214 can also be configured to extract metadata information from encrypted/password protected files and compare the extracted metadata information with policy rules. In an aspect, in such a case, attributes relating to encryption technique used, strength of password, among others, can also inform part of the metadata information.

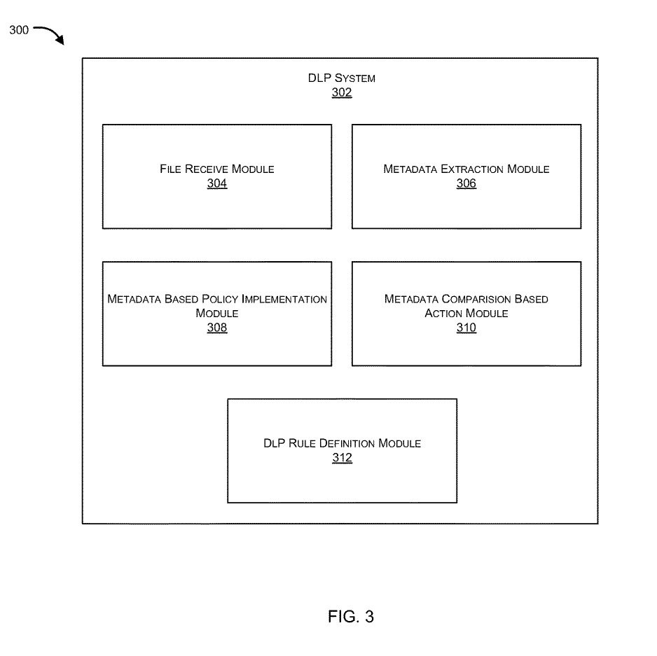

FIG. 3 illustrates exemplary functional modules 300 of a DLP system 302 that is configured to perform metadata information based file processing in accordance with an embodiment of the present invention. As illustrated in FIG. 3, system 302 can include a file receive module 304 that is configured to receive a file and/or network packet(s), a metadata extraction module 306 that is configured to extract metadata information from the received file, a metadata based policy implementation module 308 that is configured to process the extracted metadata information based on one or more pre-defined rules, and a metadata comparison based action module 310 that is configured to take an action on the file and/or on the network packet(s) and/or on the sender/initiator of the file, based on the outcome of the processing of the metadata based policy implementation module 308.

In an aspect, DLP system 302 can be implemented within any existing layer-2 or layer-3 network/gateway device or within a web server/application server. In such configuration, file receive module 304 can be configured to receive network data packets/files as captured by the layer-2 and layer-3 devices. In an implementation, DLP system 302 can be implemented as a standalone network security device, or as a software application on an existing general-purpose computer. In another implementation, file receive module 304 can be configured to be implemented within a general purpose computing device that has access of data packets that are transmitted over a network so as to be able to detect if the data packets are being transferred by a user to an authorized user/device. In an embodiment, file receive module 304 can further be configured to receive files/data packets from a network device/network controller so as to minimize unnecessary network delay. In another implementation, file receive module 304 can be configured to receive all or part of the files that are being transmitted through a computing device on which the module 304 is implemented.

In an implementation, metadata extraction module 306 can be configured to extract metadata information from the received file, wherein the metadata information can include one or combination of descriptive attributes of the file/packet (such as length, history, creator, timestamp, among other parameters of the file), structural attributes of the files/packet (extension, format of storage, format of the header, format of the payload section, among other like parameters), administrative attributes of the file/packet (creation date, modification history, users who have modified the file, access rights given on the file, among other like information), title of the file, creation details, modification details, type of file, format details, identifier details, language details, location details, actions taken on the file, purpose of the file, right related to the file, platform of the file, company to which the file belongs, owner of the file, author of the file, source IP address of file/packet, destination IP address of the file/packet, electronic marker indicative of classified file, security parameters of the file, among other information that can be construed to form part of the metadata of the file. In an example implementation, metadata information can include information that is indicative of content inside a file/network packet. In an implementation, metadata extraction module 306 can be configured to extract metadata based on any or a combination of type of the file, creator of the file, data stored in the file, format of the file, data of creation of the file, date of modification of the file, sender of the file, desired purpose of processing the file, configured security policies, and configured information attributes.

In an aspect, metadata extraction module 306 can also be configured to derive one or more attributes from existing metadata information. For instance, location of the sender and receiver can be determined based on IP address, MAC address, GPS data (if available), access point (AP) used, and other such metadata readily available in the network packet.

In an example implementation, metadata based policy implementation module 308 can be configured to, based on one or more defined rules, process the extracted metadata information. One or more of such defined rules can be based on descriptive attributes of the file/packet, structural attributes of the files/packet, administrative attributes of the file/packet, title of the file, creation details, modification details, type of file, format details, identifier details, language details, location details, actions taken on the file, purpose of the file, right related to the file, platform of the file, company to which the file belongs, owner of the file, author of the file, source IP address of file/packet, destination IP address of the file/packet, electronic marker indicative of classified file and other security parameters of the file. Therefore, depending on the file (including sender thereof) and attributes related thereto, a set of rules can be retrieved from a database of rules, and then processed with the metadata information that is extracted from the subject file.

In an implementation, metadata based policy implementation module 308 can be configured to determine if the extracted metadata contains any information that is part of a defined metadata bank. Module 308 may be configured to maintain and manage a metadata bank storing typical metadata information attributes that are indicative of, for instance, malicious content, virus, network level threat, confidential content, privileged information, wherein such a bank/database can be updated at regular intervals. In an implementation, metadata based policy implementation module 308 may also include a policy rule database storing a list of policy rules along with their definition in a manner such that the module 308 can be configured to compare the extracted metadata with the metadata available in the metadata bank using one or more policy rules. Set of policy rules that need to be applied on extracted metadata information can be changed based on multiple factors such as type of file, user/sender sending the file, importance associated with the file, department sending the file, number of time the file has been opened, among other like factors.

In an aspect, when the file at issue is an image file and includes, for instance, EXIF information, at least one rule of the one or more defined rules can be configured to process the EXIF information to determine if the EXIF information includes or is indicative of the existence of malicious data. Similarly, for different file types, different policy rules can be implemented to check for specific extracted metadata information, and evaluate if such metadata information is indicative of a confidential/privileged/malicious file or if the file is safe to be sent.

In another aspect, policy rules can also be defined/managed/modified by organizations. For instance, one policy can indicate that they would like to block all files that have the author as “Mr. XYZ”, whereas another policy can indicate they would like to block all jpg files that have the publisher as “ABC”, and yet another policy can indicate that they would like to block all .doc files that have been marked as SPAM by over 10 different users, all of which information can be retrieved from the metadata information. All other like policies and definitions thereof are completely within the scope of the present disclosure. As mentioned above, policies can also be selected from a group of policies based on factors such as department/sender of the file, time of file receipt, additional/unexpected metadata information associated with the file, among other like factors. For instance, .doc files being sent by the Intellectual Property (IP) department may be processed in a different manner from .doc files sent by the Administration department irrespective of the file type.

In an implementation, metadata comparison based action module 310 can be configured to take an action on the file and/or the sender of the file based on outcome of the processing. Depending on the processing of the extracted metadata information with respect to one or more policy rules, metadata comparison based action module 310 can take one or more actions to prevent data leak or manage file transmission. In an implementation, module 310 can be configured to block transmission of files/data packets that have metadata information matching with stored/classified metadata. Module 310 can also be configured to restrict and/or block the sender of the file if the outcome of the policy rule based processing is negative, such as when the file is evaluated to be confidential. In an implementation, the module 310 can also be configured to send an alert to the network administrator or another appropriate authority about a detected data leak.

In an aspect, module 310 can be configured to take one or a combination of actions such as blocking the file, allowing the file, blocking the sender of the file, erasing metadata of the file, modifying metadata of the file, logging the file, classifying the file in a category, classifying the sender of the file in a class, generating a security alert, changing attributes of the file, quarantining the file, among any other customized action.

In an aspect, DLP system 302 may include a dedicated DLP rule definition module 312 that can be configured to enable an administrator to define one or more policy rules based on which extracted metadata information can be processed. Module 312 can be configured to receive rule definitions from any central DLP rule definition database or from a rule definition database of other DLP systems, based on which one or more new rules can be defined or previous rules can be modified based on organizational preferences/policies. In an implementation, based on the statistics of last detected data leak, type of data leak, and frequency of data leak from particular department and/or sender, DLP rule definition module 312 can be configured to create (manually or automatically) one or more rules of itself or can suggest the administrator to create/validate such rules. For instance, if the DLP system 302 based on its historical log detects that the data leak is frequent from the finance department, module 312 can create one or more policy rules specifically for the finance department or can suggest the administrator to create more restrictions on the communications that are being initiated from the finance department.

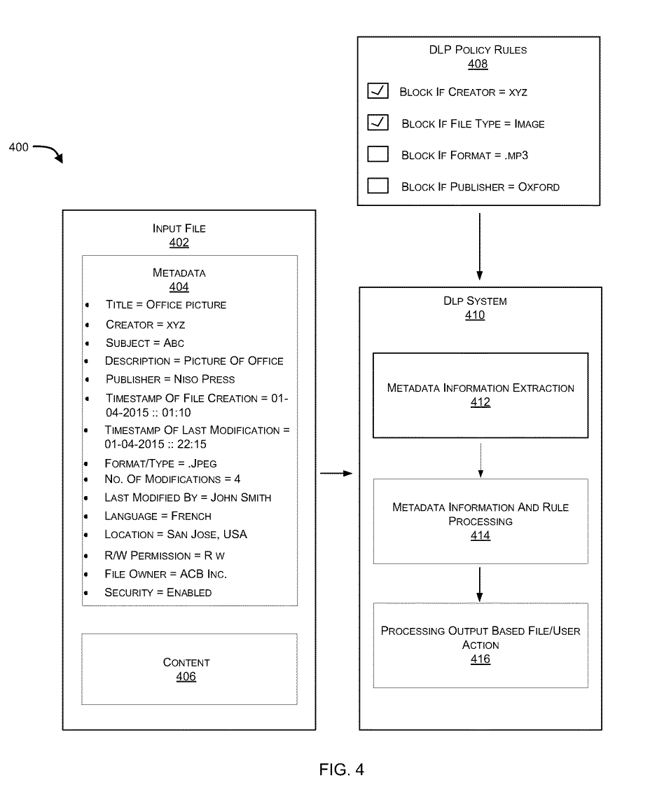

FIG. 4 illustrates an exemplary representation 400 of metadata information based file processing in accordance with an embodiment of the present disclosure. As shown, DLP system 410 can be configured to receive a file 402 and extract metadata information 404 therefrom, wherein the metadata information 404 can include, but is not limited to, title of the file, creator of the file, subject of the file, description, published details, timestamp, modification details, security details, location details, among other like details as shown in 404. Any other detail/attribute that is known to be a part of metadata information 404 is completely within the scope of the present disclosure. As shown, file 402 can also include content 406, which, in accordance with various embodiments of the present disclosure, is not referred to and/or analyzed in order to enable action to be taken on a file solely based on the metadata information 404.

As also shown, DLP system 410 can receive one or more DLP policy rules 408 that are configured to evaluate the extracted metadata information. Such rules 408 can be customized and/or configurable or can be a static set of rules for all files and types thereof. As shown, one policy rule can state that if the metadata information of the “creator” field of the file is “XYZ”, the file is to be blocked. Similarly, a second rule can state that if the metadata information of the “file type” field is an image, the file is to be blocked. Any other policy rule can be incorporated and enabled/disabled based on administrator's discretion or automatically based on the file type, sender details, file priority/importance, receiver details, among other like parameters.

In an aspect, as shown, DLP system 410 can be configured to extract metadata information 404 at block 412 and, at block 414, process the extracted metadata information with the received policy rules. At block 416, based on the output of the processing of the extracted metadata information with the received policy rules, an action can be taken on the received file.

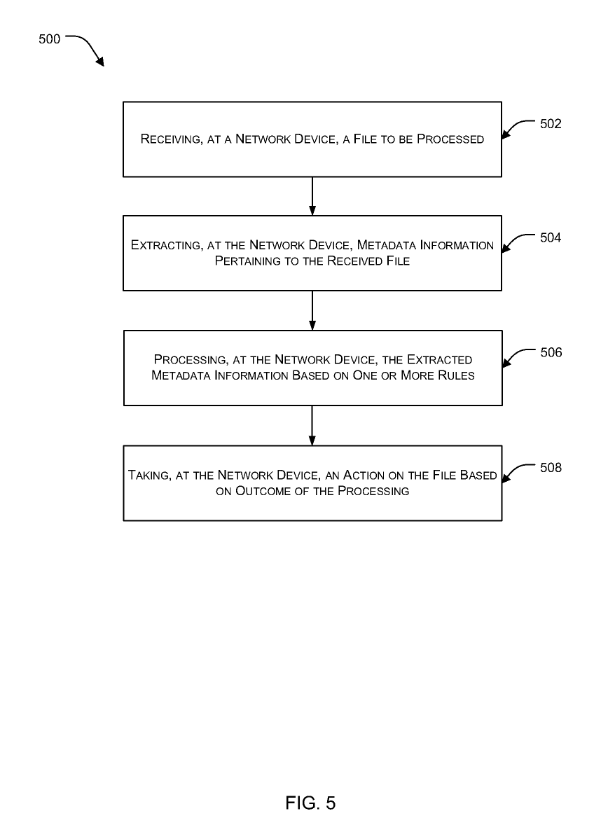

FIG. 5 illustrates an exemplary flow diagram 500 showing metadata information based file processing in accordance with an embodiment of the present invention. As shown, at step 502, the method can include receiving a file, and at step 504, the method can include extracting metadata information from the file. At step 506, the method can include processing the extracted metadata information based on one or more defined rules, and finally at step 508, taking an action on one or more of the file or a sender of the file based on an outcome of the processing.

In an aspect, the extracted metadata information can include one or a combination of descriptive attributes of the file, structural attributes of the file, administrative attributes of the file, title, creation details, modification details, a type of the file, format details, identifier details, language details, location information indicative of where the file was created, time information indicative of when the file was created, actions taken on the file, a purpose of the file, rights relating to the file, a platform of the file, a unique device identifier associated with a device that created the file, a company to which the file belongs, and security parameters of the file.

In yet another aspect, action that can be taken on the file/sender can include one or a combination of blocking the file, allowing the file, blocking the sender of the file, removing all or some portion of the metadata information from the file, modifying all or some portion of the metadata information from the file, logging the file, classifying the file in a category, classifying the sender of the file in a class, generating a security alert, changing attributes of the file, and quarantining the file.

In another aspect, when a format of the file comprises Exchangeable Image File Format (EXIF), then at least one rule of the one or more defined rules processes the extracted metadata information to determine whether a known pattern of attack is present within the extracted metadata information.

According to one embodiment, extracted metadata information can include global positioning system (GPS) coordinates that are processed with at least one rule of the one or more defined rules. In another aspect, the metadata information can be extracted based on any or a combination of a type of the file, a creator of the file, data stored in the file, a format of the file, a date of creation of the file, a date of modification of the file, a sender of the file, a desired purpose of processing the file, configured security policies, and configured information attributes. In yet another aspect, metadata information of the file can be updated in real-time.

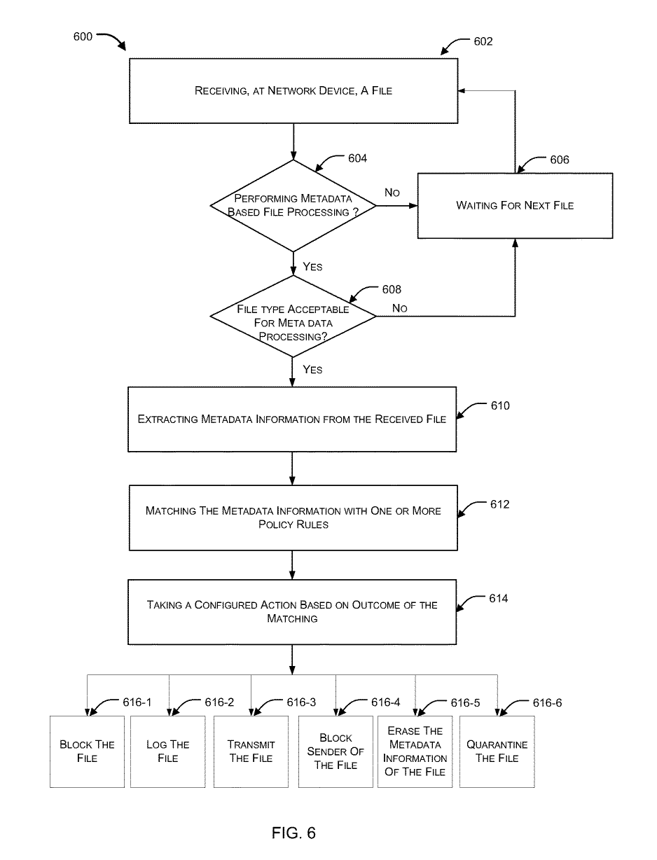

FIG. 6 illustrates another exemplary flow diagram 600 showing metadata information based file processing in accordance with an embodiment of the present invention. At step 602, the method can include receiving a file and at step 604, it can be checked if metadata information based file processing is to be performed. As certain senders/departments/IP addresses/receivers are known to be authentic or known to carry non-confidential information, metadata information for files transmitted from them may not be need to be checked against a defined set of rules.

At step 606, when metadata information based file processing is not to be performed, the system can wait to receive the next file and the flow can go back to step 602. On the other hand, when it is determined that metadata information based file processing is to be performed, at step 608, it can be checked if the file type of the received file is acceptable for metadata information extraction. When the file type is found to be non-compatible or non-acceptable for metadata information based processing for any reason, processing may return to step 606, else at step 610, metadata information can be extracted from the received file. At step 612, the extracted metadata information can be matched against one or more policy rules, and at 614, a configured action (selected from any of 616-1, 616-2, . . . , 616-n) can be taken based on the outcome of the matching.

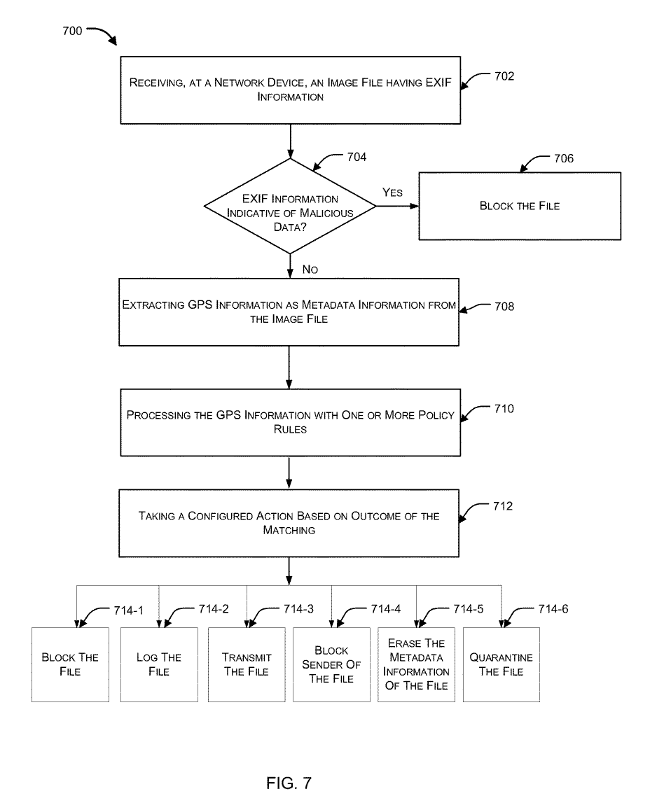

FIG. 7 illustrates yet another exemplary flow diagram 700 showing metadata information based image file processing in accordance with an embodiment of the present invention. At step 702, an image file having EXIF information as part of its metadata information is received by a network device. At step 704, it is determined whether the EXIF information is indicative of the existence of malicious data. If the determination is affirmative, at step 706, the system may be configured to block the image file, otherwise at step 708, GPS information can be extracted from the received image file. At step 610, the extracted GPS information can be processed against one or more policy rules, and at 712, a configured action (selected from any of 714-1, 714-2, . . . , 714-n) can be taken based on the outcome of the matching. Those skilled in the art will appreciate that these are exemplary flow diagrams that have been described merely to illustrate various aspects of the disclosure in a completely non-limiting matter, and therefore any other configuration/flow/process that uses metadata information based file processing based on one or more policy rules is completely within the scope of the present disclosure.

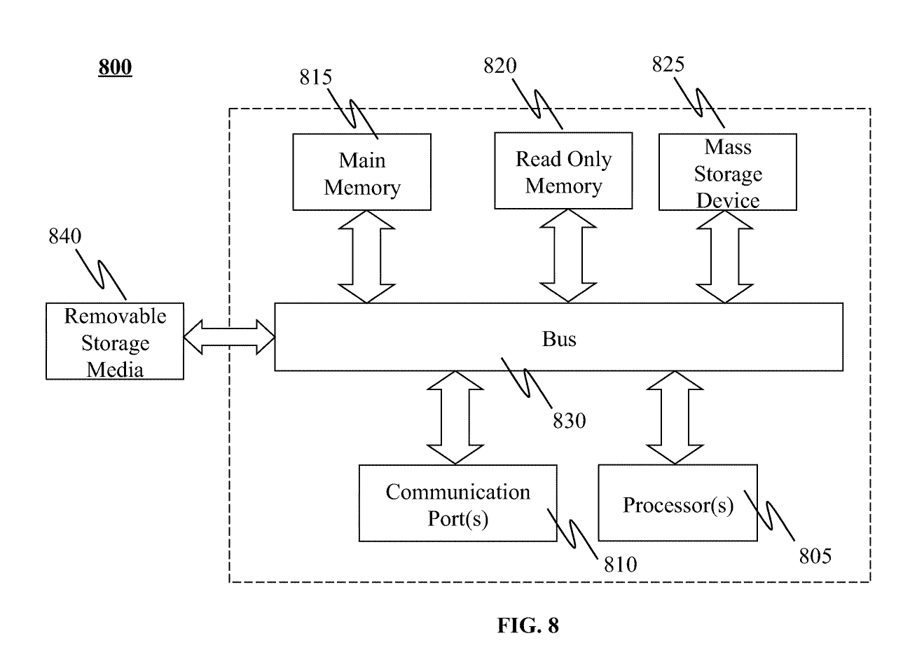

FIG. 8 is an exemplary computer system with which embodiments of the present invention may be utilized. Embodiments of the present invention include various steps, which have been described above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware. As such, FIG. 8 is an example of a computer system 800, such as a network gateway device (e.g., network gateway device 108), a server, a client system or other appropriate network security appliance in which DLP processing is typically performed.

According to the present example, the computer system includes a bus 830, one or more processors 805, one or more communication ports 810, a main memory 815, a removable storage media 840, a read only memory 820 and a mass storage 825.

Processor(s) 805 can be any future or existing processor, including, but not limited to, an Intel® Itanium® or Itanium 2 processor(s), or AMD® Opteron® or Athlon MP® processor(s), or Motorola® lines of processors. Communication port(s) 810 can be any of an RS-232 port for use with a modem based dialup connection, a 10/100 Ethernet port, a Gigabit port using copper or fiber or other existing or future ports. Communication port(s) 810 may be chosen depending on a network, such as a Local Area Network (LAN), Wide Area Network (WAN), or any other network to which the computer system 800 connects.

Main memory 815 can be Random Access Memory (RAM), or any other dynamic storage device(s) commonly known in the art. Read only memory 820 can be any static storage device(s) such as Programmable Read Only Memory (PROM) chips for storing static information such as start-up or BIOS instructions for processor 805.

Mass storage 825 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 830 communicatively couples processor(s) 805 with the other memory, storage and communication blocks. Bus 830 can include a bus, such as a Peripheral Component Interconnect (PCI)/PCI Extended (PCI-X), Small Computer System Interface (SCSI), USB or the like, for connecting expansion cards, drives and other subsystems as well as other buses, such as front side bus (FSB), which connects the processor(s) 805 to system memory.

Optionally, operator and administrative interfaces, such as a display, keyboard, and a cursor control device, may also be coupled to bus 830 to support direct operator interaction with computer system 800. Other operator and administrative interfaces can be provided through network connections connected through communication ports 810.

Removable storage media 840 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM). In no way should the aforementioned exemplary computer system limit the scope of the invention.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

What is claimed is:

1. A system comprising:
one or more processors; and
a memory containing therein:
a file receive module configured to receive a file;
a metadata extraction module configured to extract metadata information relating to the file;
a metadata based policy implementation module configured to process extracted metadata information based on one or more defined rules; and
a metadata comparison based action module configured to take an action on the file and/or sender of the file based on an outcome of the processing.

2. The system of claim 1, wherein the metadata information comprises one or a combination of descriptive attributes of the file, structural attributes of the file, administrative attributes of the file, title, creation details, modification details, an indication regarding a type of the file, format details, identifier details, language details, location details, actions taken on the file, purpose of the file, rights relating to the file, platform of the file, company to which the file belongs, and security parameters of the file.

3. The system of claim 1, wherein the action comprises one or a combination of blocking the file, allowing the file, blocking the sender of the file, erasing all or a portion of the metadata information, modifying all or a portion of the metadata information, logging the file, classifying the file in a category, classifying the sender of the file in a class, generating a security alert, changing attributes of the file, and quarantining the file.

4. The system of claim 1, wherein when the file is an image file and includes Exchangeable Image File Format (EXIF) information, at least one rule of the one or more defined rules processes the EXIF information to determine whether the EXIF information indicates the existence of malicious data.

5. The system of claim 1, wherein Global Positioning System (GPS) coordinates of the file are determined and processed with at least one rule of the one or more defined rules, and wherein an action is taken on the file based on an outcome of the processing.

6. The system of claim 1, wherein the metadata information to be extracted is configurable.

7. The system of claim 1, wherein the metadata information is extracted based on any or a combination of a type of the file, a creator of the file, data stored in the file, a format of the file, a date of creation of the file, a date of modification of the file, a sender of the file, a desired purpose of processing the file, one or more configured security policies, and one or more configured information attributes.

8. The system of claim 1, wherein the one or more defined rules are configurable and selectable.

9. The system of claim 1, wherein content stored in the file is processed along with the extracted metadata information to determine the action.

10. The system of claim 1, wherein the metadata information of the file is updated in real-time.

11. A method comprising:
receiving, by a network security appliance, a file;
extracting, by the network security appliance, metadata information from the file;
processing, by the network security appliance, the extracted metadata information based on one or more defined rules; and
taking an action, by the network security appliance, on one or more of the file or a sender of the file based on an outcome of the processing.

12. The method of claim 11, wherein the extracted metadata information comprises one or a combination of descriptive attributes of the file, structural attributes of the file, administrative attributes of the file, title, creation details, modification details, an indication regarding a type of the file, format details, identifier details, language details, location details, actions taken on the file, purpose of the file, rights relating to the file, platform of the file, company to which the file belongs, and security parameters of the file.

13. The method of claim 11, wherein the action comprises one or a combination of blocking the file, allowing the file, blocking the sender of the file, erasing all or a portion of the metadata information, modifying all or a portion of the metadata information, logging the file, classifying the file in a category, classifying the sender of the file in a class, generating a security alert, changing attributes of the file, and quarantining the file.

14. The method of claim 11, wherein when a format of the file comprises Exchangeable Image file Format (EXIF), then at least one rule of the one or more defined rules processes the extracted metadata information to determine whether a known pattern of attack is present within the extracted metadata information.

15. The method of claim 11, wherein the extracted metadata information includes global positioning system (GPS) coordinates that are processed with at least one rule of the one or more defined rules.

16. The method of claim 11, wherein the metadata information to be extracted is configurable.

17. The method of claim 11, wherein the metadata information is extracted based on any or a combination of a type of the file, a creator of the file, data stored in the file, a format of the file, a date of creation of the file, a date of modification of the file, a sender of the file, a desired purpose of processing the file, one or more configured security policies, and one or more configured information attributes.

18. The method of claim 11, wherein the one or more defined rules are configurable and selectable.

19. The method of claim 11, wherein content stored in the file is processed along with the extracted metadata information to determine the action.

20. The method of claim 11, wherein metadata information of the file is updated in real-time.
